(19) United States
(12) Patent Application Publication
(10) Pub. No.: US 2009/0129616 A1
(43) Pub. Date: May 21, 2009

(54) Hearing Device Having a Mechanical Display Element

(75) Inventors: Lilyana Joeng, Singapore (SG); Wee Haw Koo, Singapore (SG); Meng Kiang Lim, Singapore (SG); Poh Chye Lim, Singapore (SG)

Correspondence Address: LERNER GREENBERG STEMER LLP, P O BOX 2480, HOLLYWOOD, FL, 33022-2480, US

(73) Assignee: SIEMENS MEDICAL INSTRUMENTS PTE. LTD., Singapore (SG)

(21) Appl. No.: 12/275,541

(22) Filed: Nov. 21, 2008

(30) Foreign Application Priority Data
Nov. 21, 2007 (DE) 10 2007 055 551.4

(51) Int. Cl. H04R 25/00

(52) U.S. Cl. 381/323; 381/328

(57) ABSTRACT

A hearing device for wearing in or on the ear and for outputting a sound to the ear includes an electronic unit and a display unit for displaying a state of the electronic unit and for easily detecting the state of a hearing device such as a hearing aid while using as little energy as possible. The display unit has a display element that can be moved mechanically, depending on the state of the electronic unit, into a position specific to the state. It is possible to use the display unit to display the switched-on state and the switched-off state of a hearing aid. In particular, it is advantageous to couple the display element mechanically to a battery compartment when the battery compartment is used to switch the hearing aid or the hearing device on and off. However, the display element can also be moved by magnetic or electrical forces.

### CROSS-REFERENCE TO RELATED APPLICATION

This application claims the priority, under 35 U.S.C. § 119, of German Patent Application DE 10 2007 055 551.4, filed Nov. 21, 2007; the prior application is herewith incorporated by reference in its entirety.

### BACKGROUND OF THE INVENTION

### Field of the Invention

The present invention relates to a hearing device for wearing in or on the ear and for outputting a sound to the ear and which has an electronic unit and a display unit for displaying a state of the electronic unit. A hearing device is understood herein as, in particular, a hearing aid, a headset, headphones and the like.

Hearing aids are wearable hearing devices that serve to assist the hearing impaired. Different constructions of hearing aids, such as behind-the-ear (BTE) hearing aids, a hearing aid with an external receiver (RIC: receiver in the channel), and in-the-ear (ITE) hearing aids, for example including concha hearing aids or channel hearing aids (ITE, CIC) are provided in order to meet numerous individual requirements. The hearing aids listed by way of example are worn on the outer ear or in the auditory canal. However, bone conduction hearing aids and implantable or vibrotactile hearing aids are furthermore available on the market. In that case, damaged hearing is stimulated either mechanically or electrically.

In principle, the important components of hearing aids are an input transducer, an amplifier and an output transducer. As a rule, the input transducer is a sound receiver, for example a microphone, and/or an electromagnetic receiver, for example an induction coil. The output transducer is mostly implemented as an electroacoustic transducer, for example a miniature loudspeaker, or as an electromechanical transducer, for example a bone conduction receiver. The amplifier is usually integrated in a signal processing unit. That construction principle is illustrated in FIG. 1 using the example of a behind-the-ear hearing aid. One or more microphones 2 for receiving sound from the environment are built into a hearing aid housing 1 for wearing behind the ear. A signal processing unit 3, which is likewise integrated in the hearing aid housing 1, processes microphone signals and amplifies them. An output signal of the signal processing unit 3 is transmitted to a loudspeaker or receiver 4 that outputs an acoustic signal. The sound is transmitted to the ear drum of the hearing aid wearer, if appropriate through a sound tube that is fixed in the auditory canal with an otoplastic. The power supply of the hearing aid and, in particular, that of the signal processing unit 3 is provided by a battery 5, which is likewise integrated in the hearing aid housing 1.

Hearing aids are generally switched off when they are not being worn. Conversely, when they are being worn they are switched on by the hearing aid wearer, at least supposedly. Particularly in the case of small children and elderly persons, it can certainly happen that the hearing aid is not switched on when being worn, or is only switched on incorrectly (with the battery compartment being incompletely closed, for example). It is therefore desirable for the person caring for the hearing aid wearer to be able to check the state of the hearing aid quickly.

Modern hearing aids have a multiplicity of functions. For example, they can be switched to various hearing programs. It is also not possible in that case to rule out faulty operation, particularly by relatively young and elderly hearing aid wearers. Consequently, the caregiver should also be capable in that case of identifying the function of the hearing aid simply and quickly.

It is known to display the state of a hearing aid, for example switched-on and switched-off states, through the use of an LED on the hearing aid housing. Moreover, the state of the hearing aid can also be read off on a remote control, for example, to which appropriate data are transmitted by the hearing aid. Furthermore, it is known to check the battery charge state by removing the battery from the hearing aid and inserting it into an appropriate measuring instrument.

U.S. Patent Application Publication No. US 2007/177749 A1 discloses an ITE (in-the-ear) hearing aid having an electric circuit in which an on/off switch is integrated. The switch is constructed as a rotary switch and is actuated by a sliding movement along a circular segment. The on/off switching state can therefore be identified from outside at the switch itself.

The known display and state testing techniques have the following disadvantages: LEDs for state displays have a relatively high current consumption, something which is critical for hearing aids. The majority of the hearing aid systems do not have a remote control through which a state of the hearing aid could be displayed. As far as checking the state of a battery through the use of a battery measuring instrument is concerned, there is the evident disadvantage that a battery measuring instrument is not available on every occasion.

### SUMMARY OF THE INVENTION

It is accordingly an object of the invention to provide a hearing device having a mechanical display element, which overcomes the hereinafore-mentioned disadvantages of the heretofore-known devices of this general type and which makes it possible to quickly check the state of a hearing device and, in particular, a hearing aid, without a high outlay and without a high level of energy consumption.

With the foregoing and other objects in view there is provided, in accordance with the invention, a hearing device for wearing in or on the ear and for outputting a sound to the ear. The hearing device comprises an electronic unit and a display unit for displaying a state of the electronic unit. The display unit has a display element being moved mechanically, depending on the state of the electronic unit, into a position specific to the state.

Due to the mechanically movable display element, it is advantageously possible to save energy, since energy is consumed only for the movement, but not in the static state, in contrast with an LED in which a specific state is displayed by illumination. However, it is advantageous that mechanical displays can mostly be configured in an effectively readable fashion without a high outlay.

In accordance with another feature of the invention, the display element can be displaced linearly into a number of positions. Electrical and magnetic forces can generally be converted easily into linear movements.

In accordance with a further feature of the invention, the display element can also be pivoted into a number of positions. This can be necessary or advantageous for geometrical reasons.

In accordance with an added feature of the invention, the state of the electronic unit that is to be displayed preferably refers to the switched-on state and the switched-off state. It is important precisely in these states to provide an appropriate display and, in the process, to profit from a low level of energy consumption.

In accordance with an additional feature of the invention, the display element can be moved by magnetic force of a magnetic component of the electronic unit. It is possible in this case to incorporate a dedicated magnetic component in the hearing device, or one already present can be used. Thus, for example, it is possible to produce the magnetic force by a receiver coil, a telephone coil, a data transmission coil or a coil of a reed relay.

Alternatively, the display element can be moved by the force of an electric field of a component of the electronic unit. Thus, for example, the repulsive or attractive force of electric charges can be used for the movement of the display element, for example by charging two electrodes.

In accordance with a concomitant feature of the invention, it is particularly advantageous if the hearing device has a battery flap with which the hearing device can be switched on and switched off. The display element is mechanically coupled to the battery flap in such a way that the display element is also moved during movement of the battery flap. In this case, the user of the hearing device applies the energy to move the display element without, for example, loading the battery of the hearing device. In concrete terms, for example, the battery flap can be constructed as a battery compartment, and in order to switch on the hearing device, the battery compartment is inserted or pivoted into the latter, with the display element also being moved in the process.

Other features which are considered as characteristic for the invention are set forth in the appended claims.

Although the invention is illustrated and described herein as embodied in a hearing device having a mechanical display element, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWINGS

FIG. 1 is a longitudinal-sectional view showing the structural principle of a hearing aid in accordance with the prior art;

FIG. 2 is a side-elevational view of an example of a BTE hearing aid according to the invention having a mechanical display, in a switched-off state; and

FIG. 3 is a side-elevational view of the hearing aid of FIG. 2 in a switched-on state.

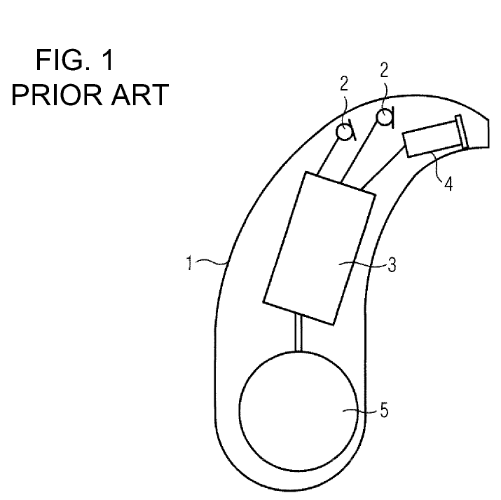

### DETAILED DESCRIPTION OF THE INVENTION

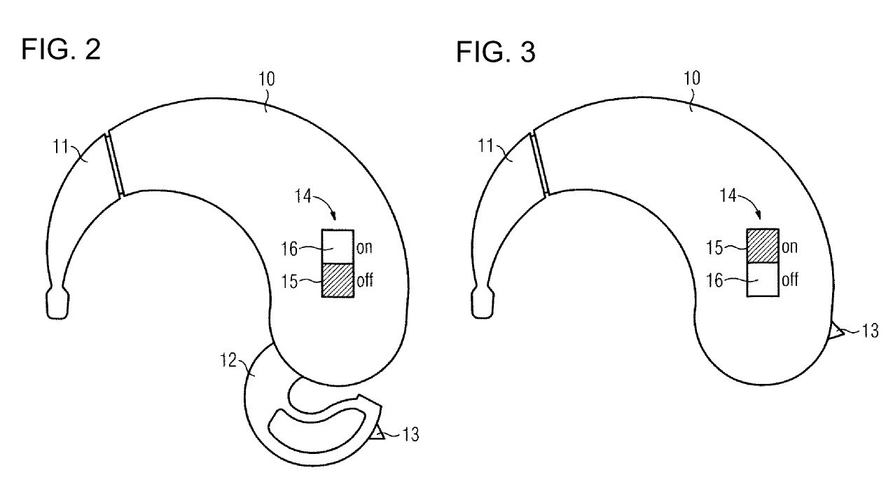

Referring now to the figures of the drawings in detail and first, particularly, to FIG. 2 thereof, there is seen an exemplary embodiment which is outlined in more detail below and constitutes a preferred embodiment of the present invention.

A BTE hearing aid, which is illustrated in a side view in FIG. 2, has a hearing aid shell 10 on which a supporting hook 11 is fastened. A battery compartment or flap 12 is disposed at an end of the hearing aid shell 10 opposite the supporting hook 11. The battery compartment 12 can be pivoted into a corresponding cutout in the hearing aid shell 10. The battery compartment 12 serves in this case not only to close a battery opening, but also to hold a battery, which is not illustrated in FIG. 2.

In the present case, the pivotable battery compartment is also used to switch the hearing aid on and off. On one hand, the hearing aid is switched off if the battery compartment is pivoted out as illustrated in FIG. 2. On the other hand, the hearing aid is switched on when the battery compartment 12 is pivoted into the hearing aid shell 10. This state is reproduced in FIG. 3. Only a projection 13 then protrudes from the contour of the hearing aid shell 10, thereby facilitating the opening of the battery compartment 12.

A display 14 is incorporated into the hearing aid shell 10 in order to check the switched-on and switched-off states of the hearing aid. The display 14 is formed of a window 15 behind which a display element 16 can be linearly displaced. In the present example, the display element 16 is divided by colors into two areas in such a way that its position can be directly determined in the window 15 and be assigned to a state, in this case “on” or “off”.

The display element 16 is mechanically coupled to the battery compartment 12. The display element 16 is pulled downward in the example of FIG. 2 because of the opened battery compartment 12. The dark marking of the display element 16 is therefore assigned to the marking of the “off” state. If, by contrast, as is shown in FIG. 3, the battery compartment 12 is pivoted into the hearing aid shell 10, the display element 16 is pushed upward in such a way that its dark region is opposite the marking of “on”, which characterizes the switch-on operation.

The display element 16 can not only be moved mechanically, but also magnetically, for example. It is possible to this end to make use of a receiver coil, a telephone coil, a data transmission coil or any desired other coil that is already integrated for another purpose in the hearing aid or in the hearing aid device, or is installed specifically for the display. Alternatively, an electric current or electric charge can also be used in order to move the display element 16.

The mechanical display device has been explained in conjunction with FIGS. 2 and 3 on a BTE hearing aid. However, this display device can also be used for other hearing devices such as, for example, ITE hearing aids, etc. It is advantageous in this case that little current is consumed from the display, and that it is easy to identify whether or not the user or hearing damaged person has activated his or her aid. In particular, it is then not necessary to remove the hearing aid or the hearing device from the ear in order to identify the state of the hearing aid/hearing device.

1. A hearing device for wearing in or on the ear and for outputting a sound to the ear, the hearing device comprising:
an electronic unit; and
a display unit for displaying a state of said electronic unit;
said display unit having a display element being moved mechanically, depending on said state of said electronic unit, into a position specific to said state.

2. The hearing device according to claim 1, wherein said display element is configured to be displaced linearly into a number of positions.

3. The hearing device according to claim 1, wherein said display element is configured to be pivoted into a number of positions.

4. The hearing device according to claim 1, wherein said state of said electronic unit is a switched-on state and a switched-off state.

5. The hearing device according to claim 1, wherein said electronic unit has a magnetic component exerting a magnetic force moving said display element.

6. The hearing device according to claim 5, wherein the magnetic force is produced by a coil selected from the group consisting of a receiver coil, a telephone coil, a data transmission coil and a coil of a reed relay.

7. The hearing device according to claim 1, wherein said electronic unit has a component with an electric field exerting a force moving said display element.

8. The hearing device according to claim 1, which further comprises a battery flap for switching the hearing device on and off, said display element being mechanically coupled to said battery flap for moving said display element during movement of said battery flap.

9. The hearing device according to claim 8, wherein said battery flap is constructed as a battery compartment.

10. The hearing device according to claim 1, which further comprises a component being movable to enable the hearing device to be switched on and off, said display element being moved by mechanical coupling to said component.
